(19) United States
(12) Patent Application Publication
(10) Pub. No.: US 2026/0100986 A1
(43) Pub. Date: Apr. 9, 2026

(54) DEVICE FOR MONITORING A DISTRIBUTED ALARM SYSTEM

(71) Applicant: B. Braun Melsungen AG, Melsungen (DE)

(72) Inventors: Jan Schwarz, Melsungen (DE); Martin Kasparick, Hildesheim (DE); Michael Duesterhus, Hessisch Lichtenau (DE)

(21) Appl. No.: 19/343,565

(22) Filed: Sep. 29, 2025

(30) Foreign Application Priority Data
Oct. 4, 2024 (EP) 24204777.7

(51) Int. Cl. H04L 67/12; G08B 29/12

(52) U.S. Cl. CPC H04L 67/12; G08B 29/12

(57) ABSTRACT

A device is operable to monitor a distributed alarm system having a server and a medical device connected to the server by a communication link. The device has a detecting unit for detecting a communication link between the server and the medical device. The detecting unit also detects operating data for the medical device. The detecting unit can further detect a termination of the communication link between the server and the medical device. The device includes an ascertaining unit that ascertains whether a termination of the communication link is unintentional or intentional, based on the detected operating data. The device further includes a transmitting unit that transmits a first signal when an unintentional termination is ascertained, and transmits a second signal when an intentional termination is ascertained. The first signal can include an audible alarm signal, and the second signal can be without an audible alarm signal.

### CROSS-REFERENCE TO RELATED APPLICATION

This application claims priority under 35 U.S.C. § 119 to European Application No. 24204777.7, filed on October 4, 2024, the content of which is incorporated by reference herein in its entirety.

### FIELD

The present disclosure relates to a device for monitoring a distributed alarm system, a computer-implemented method for monitoring a distributed alarm system, a computer program, a computer-readable storage medium, and a medical monitoring system.

### BACKGROUND

Distributed alarm systems in medical environments are well known. Distributed alarm systems are security systems in which the alarm functions are distributed across several geographically separate or functionally independent components. These systems work together to ensure comprehensive security monitoring and control by collecting data from various sensors and devices, processing it, and forwarding it to central or decentralized control points.

Communication between components usually takes place via a network (e.g., Ethernet, WLAN, mobile communications, or other wireless protocols such as Zigbee or Z-Wave). This allows the alarm systems to be used in buildings, cities, or large areas.

Such systems can comprise various types of alarm systems, including alarms that detect when a participant, for example a medical device such as an infusion pump, is disconnected from the distributed alarm system, in particular its communication network.

The alarms can be forwarded to various endpoints, such as dashboards in hospital emergency rooms or to pagers or smartphones of hospital staff. The alarms may include audible and/or visual signals.

In this context, it has become apparent that the alarms that occur when someone intentionally leaves a distributed alarm system are perceived as disturbing by hospital staff and patients. It has also been shown that audible alarms can unsettle patients.

### SUMMARY

It is therefore the task of the present disclosure to avoid or at least reduce the disadvantages of the prior art and, in particular, to provide a device for monitoring an alarm system which disturbs or unsettles patients less.

The task of the present disclosure is solved by a device for monitoring a distributed alarm system, as well as by a method, a computer program, a computer-readable storage medium, and a monitoring system. Advantageous designs are explained below.

According to a first aspect of the present disclosure, there is provided a device for monitoring a distributed alarm system, wherein the distributed alarm system comprises at least one server and at least one medical device capable of establishing a communication link with each other, comprising: a detecting unit set up to detect the existence of a communication link between the server and the medical device, wherein the detecting unit is further set up to detect operating data for the medical device, wherein the detecting unit is further set up to detect a termination of the communication link between the server and the medical device; an ascertaining unit set up to ascertain, based on the detected operating data, whether the termination of the communication link is either an unintentional termination of the communication link or an intentional termination of the communication link; a transmitting unit set up to transmit a first signal, wherein the first signal comprises an audible alarm signal when an unintentional termination is ascertained, wherein the transmitting unit is further set up to transmit a second signal, wherein the second signal does not comprise an audible alarm signal when an intentional termination is ascertained.

The term “distributed alarm system” refers in particular to a distributed alarm system in a medical environment, such as a hospital, intensive care unit, or nursing home. In a distributed alarm system, medical devices can be connected to each other via a server. The server can receive alarm messages or alarm signals from individual medical devices, process them if necessary, and forward them to other medical devices (e.g., patient monitors, infusion pumps, ventilators) or other participating devices (e.g., smartphones, central monitoring stations).

The term “server” here refers in particular to a communication server in a network that provides communication services or data exchange between individual medical devices and/or participating devices. The server may include hardware and software.

The term “medical device” refers in particular to one of the following devices: Patient monitor, infusion pump, ventilator. The medical device may preferably have a communication interface for communicating with a server. Furthermore, the term “participant” refers, for example, to a care worker's end device (e.g., smartphone, pager) or a dashboard. The participant may be a medical device. The participant can be an infusion pump. The participant can be a patient monitor. The participant can be a ventilator.

The term “at least one medical device” specifically refers to a plurality of medical devices, for example 50 or more.

The term “communication link” refers in particular to the data exchange. If a communication link is established, it can be assumed that the medical device is registered in the distributed alarm system.

In this context, the term “detecting unit” refers in particular to a computing unit that is set up to detect the existence of a communication link between a medical device and a server. For this purpose, the processing unit can, for example, evaluate a heartbeat or a handshake as part of the communication between the medical device and the server. In particular, the detecting unit may be further set up to detect a termination of the communication link. To this end, it can evaluate a heartbeat or a handshake as part of the communication between the medical device and the server. In particular, the detecting unit may be further designed to detect operating data for the medical device. For this purpose, the detecting unit may have a data interface through which it can receive the operating data.

The term “operating data” is to be understood broadly in this context and refers in particular to data or information that provides information about an intentional or unintentional termination of the communication link between the medical device and the server. The operating data can be generated when a medical device is removed from a higher-level system. For example, the medical device may be an infusion pump that is arranged in a rack or organization system. The removal of the infusion pump from the rack or the organization system can be detected, for example, by sensors (e.g., magnetic sensor, Hall sensor) and/or a data interface (e.g., infrared, Near Field Communication, Ethernet, serial connection) between the infusion pump and the organization system. This information can be reused by classifying a future termination of the communication link as an intentional termination of the communication link. For example, the infusion pump can first be removed from the organization system. The withdrawal is detected by a magnetic sensor, which is installed in the infusion pump, for example. The infusion pump then transmits this information to the device’s detecting unit for monitoring the distributed alarm system. Furthermore, a communication link between the medical device and the server can also be deliberately terminated by a user. To do this, the user can, for example, trigger the action on the server. For this purpose, the information about the targeted termination is then made available to the detecting unit via a data interface. In this context, operating data may also include data that provides information about a temporary, intentional interruption of a communication link. Examples of this include: Software updates and maintenance work.

In this context, the term “ascertaining unit” refers in particular to a computing unit that is set up to evaluate the operating data and ascertain whether the communication link has been intentionally terminated or unintentionally terminated. To this end, the ascertaining unit can, for example, compare the detected operating data with previously defined use cases. For example, when an infusion pump is removed from an organization system, the corresponding information is transmitted to the detecting unit. The ascertaining unit can then compare this information with information stored in a table, for example. If the comparison is positive, it can now assume that the communication link was intentionally terminated.

The term “transmitting unit” refers to a unit that is set up to transmit a first and/or second signal to the medical devices and/or participating devices of the distributed alarm system.

The term signal refers specifically to a message. The message may contain one piece of information. The information may indicate a change in the status of the medical device. The change in the status may indicate that the medical device has been intentionally removed from the distributed alarm system. The change in the status may indicate that the medical device has been unintentionally removed from the distributed alarm system. The signal may include an audible warning signal. The signal may include visual information. For example, the visual information may include a text message, a display element, a display element fade-in, or a display element fade-out. The visual information can be displayed on a medical device (infusion pump) and/or a participating device (smartphone).

The disclosure is based on the realization that in distributed alarm systems, an acoustic warning signal is currently emitted, for example, at the medical device and/or a mobile terminal of a caregiver, when a participant (e.g., medical device) leaves the distributed alarm system. However, current alarm systems do not differentiate between intentional and unintentional disengagement of the alarm system. If a medical device is intentionally or deliberately disconnected from the alarm system, no audible alarm signal is required. This is unnecessary and disturbs both medical staff and patients, and makes patients feel uneasy. The disclosure suggests using operating data to detect an intentional interruption of the communication link between medical devices and servers and, in such cases, not transmitting or emitting an acoustic warning signal to participants in the distributed alarm system. However, if an unintentional termination of the communication link is detected, the device transmits an acoustic alarm signal. This reduces disturbing of the medical staff and patients while maintaining the same level of security. For example, intensive care units accommodate several patients who may be connected to a plurality of medical devices, such as infusion pumps. During maintenance work or software updates, for example, the communication links between the plurality of infusion pumps and the server may be intentionally terminated at the same time. In such cases, the present disclosure can be particularly advantageous in reducing noise levels by preventing unnecessary mass alarms. This can lead to a significant reduction in noise, especially when there are a plurality of medical devices in use. This can have a positive effect on the efficiency of the alarm system and the efficiency of medical personnel.

According to a preferred embodiment, the operating data may indicate one or more of the following situations: physical separation of medical device from distributed alarm system, software update, maintenance of medical device, maintenance of participants, maintenance of server, maintenance of gateway.

The term “physical separation” in the context of a distributed alarm system refers in particular to the intentional removal of the medical device from the distributed alarm system. For example, a medical device such as an infusion pump can be removed from an organization system as described above. The removal can be detected by a sensor (e.g., magnetic sensor, Hall sensor). The withdrawal information can then be communicated to the detecting unit so that the device does not trigger an acoustic warning signal if the communication link between the medical device and the server is terminated. Furthermore, this can be understood as the deliberate removal of the medical device from the distributed alarm system. Here, a user can, for example, interrupt the communication link from the server to the medical device and remove the medical device from the distributed alarm system. This information can then be communicated back to the detecting unit so that the device does not trigger an audible warning signal if communication link between the medical device and the server is terminated. During a software update, information about the pending software update can be communicated to the detecting unit so that the device does not trigger an audible warning signal if the communication link between the medical device and the server is terminated by the software update. The same applies to planned maintenance work on the infrastructure of the distributed alarm system. The infrastructure may include network components and operating system updates. The maintenance work may result in a loss of communication link between the medical device and the server. Information about planned maintenance work can be communicated to the detecting unit so that the device does not trigger an acoustic warning signal if the communication link between the medical device and the server is terminated by the software update. Another use case could be maintenance on the server gateway. For example, a certificate exchange can be performed at the gateway. The gateway may be temporarily unavailable while the certificates are being exchanged. The medical devices and/or participants then temporarily leave the distributed alarm system. Information about planned maintenance work on the gateway can be communicated to the detecting unit so that the device does not trigger an acoustic warning signal if the communication link between the medical device and the server is terminated due to maintenance work.

According to a preferred embodiment, the server may include a gateway for converting data logs.

By using a gateway, different medical devices that use different data protocols can communicate with each other.

This has the advantage of extending the range of the device in relation to different manufacturers or participants or medical devices with different data protocols.

According to a preferred embodiment, the first and/or second signal may comprise a visual signal.

The visual signal preferably comprises a display element that indicates the presence or absence of a communication link. The visual signal may also include a text message.

According to a preferred embodiment, the alarm system may comprise a plurality of medical devices and/or other participants.

The medical device may include one or more of the following: ventilator, patient monitor, infusion pump.

According to a preferred embodiment, the medical device may be an infusion pump.

According to a preferred embodiment, the device may be further set up to automatically re-establish a communication link between the at least one medical device and the server after the detected intentional termination of the communication link, in particular after a software update, in order to return to the distributed alarm system.

In other words, the device can provide a communication protocol that allows a communication link between the medical device and the server to be re-established after an intentional termination of the communication link, for example, a software update or maintenance. This advantageously does not require any user intervention. This can have a beneficial effect on the efficiency of the distributed alarm system.

According to a preferred embodiment, the first and/or second signal can be transmitted to the server for forwarding to further medical devices and/or participants.

In other words, the first and second signals are forwarded to other medical devices and/or participants (e.g., smartphone, central monitoring terminal, pager).

Another aspect of the present disclosure relates to a computer-implemented method for monitoring a distributed alarm system, wherein the distributed alarm system comprises at least one server and at least one medical device capable of establishing a communication link with each other, comprising the steps of: detecting the existence of a communication link between the server and the medical device; obtaining operating data for the medical device; detecting a termination of the communication link between the server and the medical device; ascertaining, based on the received operating data, whether the termination of the communication link is either an unintentional termination of the communication link or an intentional termination of the communication link; transmitting a first signal, wherein the first signal comprises an acoustic alarm signal, if an unintentional termination is ascertained;

transmitting a second signal, wherein the second signal does not comprise an acoustic alarm signal, when an intentional termination is ascertained.

According to a preferred further embodiment, the operating data may indicate one or more of the following situations: physical separation of a participant from the alarm system, software update, maintenance of participants, maintenance of a server, maintenance of a gateway.

According to a preferred further embodiment, the server may comprise a gateway for converting data logs.

According to a preferred further embodiment, the first and/or second alarm signals may comprise a visual alarm signal.

According to a preferred further embodiment, the alarm system may comprise a plurality of participants.

According to a preferred further embodiment, the at least one medical device may comprise one or more of the following: ventilator, infusion pump, patient monitor.

According to a preferred further embodiment, the method may comprise automatically re-establishing a communication link between the at least one medical device and the server after the detected intentional termination of the communication link, in particular after a software update.

Furthermore, the method may comprise steps and features which correspond to the device described above, in particular its devices or configurations.

Another aspect of the present disclosure relates to a computer program product comprising commands that, when executed by a computer, cause the computer to carry out the method described above.

Another aspect of the present disclosure relates to a computer-readable storage medium comprising commands that, when executed by a computer, cause the computer to carry out the method described above.

Another aspect of the present disclosure relates to a medical monitoring system comprising: a device for monitoring an alarm system, as described in more detail above; a server with a gateway; and a medical device, in particular an infusion pump.

Another aspect of the present disclosure relates to the use of an infusion pump in a medical monitoring system described in more detail above.

The units, devices, and equipment according to one or more exemplary embodiments may be implemented using hardware, software, and/or a combination thereof. The units, devices, and equipment may be single-piece or multi-piece. Hardware units, hardware devices, and hardware equipment can be implemented, for example, by processing circuits such as a processor, a central processing unit (CPU), a controller, an arithmetic logic unit (ALU), a digital signal processor, a microcomputer, a field-programmable gate array (FPGA), a system-on-chip (SoC), a programmable logic device, a microprocessor, or any other device capable of responding to commands and executing them in a predetermined manner.

The units, devices, and equipment may comprise one or more interface circuits. In some examples, the interface circuits may include wired or wireless interfaces connected to a local area network (LAN), the Internet, a wide area network (WAN), or combinations thereof. The functionality of a particular unit, device, or apparatus of the present disclosure may be distributed across multiple units, devices, and equipment connected via interface circuits.

The units, devices, and equipment according to one or more exemplary embodiments may also include one or more storage devices. The one or more storage devices may be physical or non-transitory computer-readable storage media, such as random access memory (RAM), read-only memory (ROM), a permanent mass storage device (e.g., a hard disk drive), a solid-state device (e.g., NAND flash), and/or any other data storage mechanism capable of storing and recording data. The one or more storage devices may be set up to store computer programs, program code, instructions, or a combination thereof.

At this point, it should be explicitly noted that medical devices such as infusion pumps or ventilators also fall under the above definitions of devices.

The explanations and advantages of individual embodiments described here also apply mutatis mutandis to the other embodiments. Various exemplary features of the embodiments may be combined according to the present disclosure wherever this is technically useful and feasible.

### BRIEF DESCRIPTION OF THE DRAWINGS

FIG. 1 shows a schematic representation of a device according to the disclosure;

FIG. 2 shows a schematic representation of a medical monitoring system according to the disclosure;

FIG. 3 shows a schematic representation of a method according to the disclosure;

FIG. 4 shows an example display of an infusion pump with an intentional termination of the communication link;

FIG. 5 shows an example display of an infusion pump in the event of an unintentional termination of the communication link; and

FIG. 6 shows an example display of an infusion pump when a communication link exists.

### DETAILED DESCRIPTION

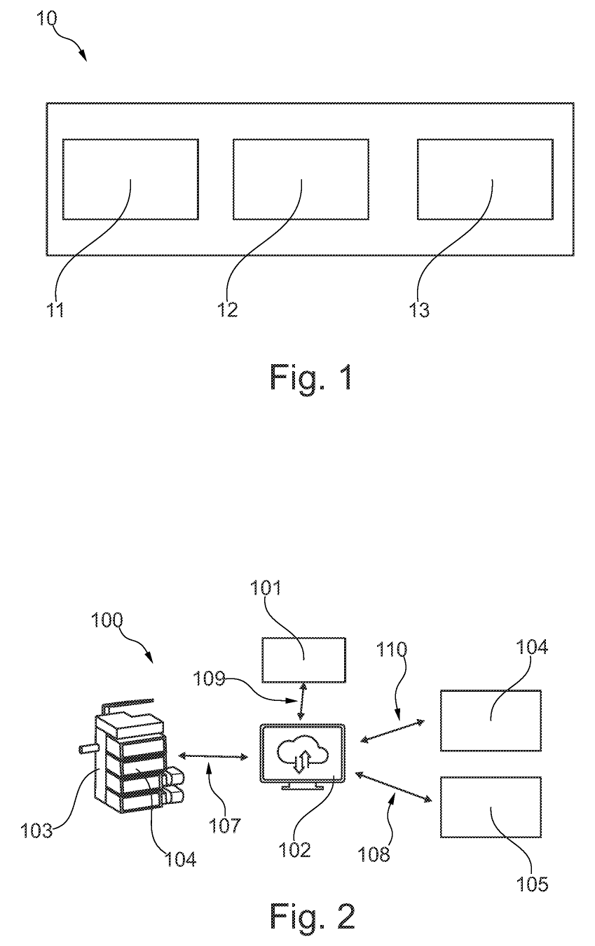

FIG. 1 shows a schematic representation of a device 10 for monitoring a distributed alarm system. The distributed alarm system can comprise, for example, at least one server with a gateway, a plurality of infusion pumps, a patient monitor, and a plurality of mobile end devices such as smartphones. The plurality of infusion pumps and patient monitors are each set up to establish a communication link with the server. Communication link is established via a wireless network, such as WLAN or an internal wireless network (DECT), or a wired connection (Ethernet). The plurality of infusion pumps, the patient monitor, the server, and the mobile devices all have the appropriate communication interfaces on both the hardware and software sides. The device 10 comprises a detecting unit 11. The detecting unit 11 is set up to detect the existence of a communication link between the server and the medical device. Furthermore, detecting unit 11 is set up to detect operating data for the infusion pump and the patient monitor. Furthermore, detecting unit 11 is set up to detect a termination of the communication link between the server and the plurality of infusion pumps and the patient monitor.

The device 10 further comprises an ascertaining unit 12 which is set up to ascertain, on the basis of the detected operating data, whether the termination of the communication link is either an unintentional termination of the communication link or an intentional termination of the communication link. Furthermore, the device 10 comprises a transmitting unit 13 that is set up to transmit a first signal, wherein the first signal comprises an acoustic alarm signal when an unintentional termination is ascertained. The transmitting unit 13 is further set up to transmit a second signal, wherein the second signal does not comprise an acoustic alarm signal, when an intentional termination is ascertained. The second signal preferably comprises only a visual signal that provides information about a change in the status of the infusion pump. In this case, the infusion pump was taken from an organization system by a member of medical staff. This activated a magnetic sensor, which indirectly transmitted a corresponding signal via a communication interface of the infusion pump as operating data to the detecting unit 11 of the device. If the communication link between the infusion pump and the server is terminated (e.g., because the infusion pump has been switched off), the ascertaining unit 12 evaluates the operating data and recognizes that the termination of the communication link is intentional. It then transmits only the second signal to the infusion pump, the patient monitor, and the mobile devices of the distributed alarm system. However, if, for example, the evaluation of the operating data by the ascertaining unit 12 ascertains that the communication link has suddenly been interrupted during ongoing treatment and that the termination of the communication link is therefore unintentional, the ascertaining unit 12 transmits the first signal, which includes the acoustic alarm signal, to the infusion pump, the patient monitor, and the mobile terminals of the distributed alarm system.

FIG. 2 schematically shows a medical monitoring system 100. The medical monitoring system 100 comprises a device 101 for monitoring a distributed alarm system, which is described in more detail in FIG. 1. The medical monitoring system 100 further comprises a server with a gateway 102 and an infusion pump 104 arranged in an organization system 103. Furthermore, a patient monitor 104 and another medical device 105, for example a ventilator, are part of the medical monitoring system 100. The infusion pump 104 is connected to the server 102 via a communication link 107. The device 101 is connected to the server 102 via a communication link 109. Alternatively, the device 101 could also be part of the server 102. Alternatively, the device 101 could also be part of the medical device 105 or the infusion pump 104. The medical device 105 is connected to the server 102 via a communication link 108. The infusion pump 104 is connected to the server 102 via a communication link 107. The communication links are radio-based in this case, for example via WLAN. Alternatively or in addition, the communication links can also be wired. For example, the connection between the server/gateway and the patient monitor and/or between the server/gateway and the ventilator may be wired. The wired communication link can be established via Ethernet. Operating data, initial signals, and secondary signals can be exchanged via the communication links. For example, the device 101 receives the information that the infusion pump 104 is being removed from the organization system as operating data. In the event of a termination of the communication link 107, device 101 then merely transmits a second signal to medical device 105 and infusion pump 104, as it has detected an intentional termination.

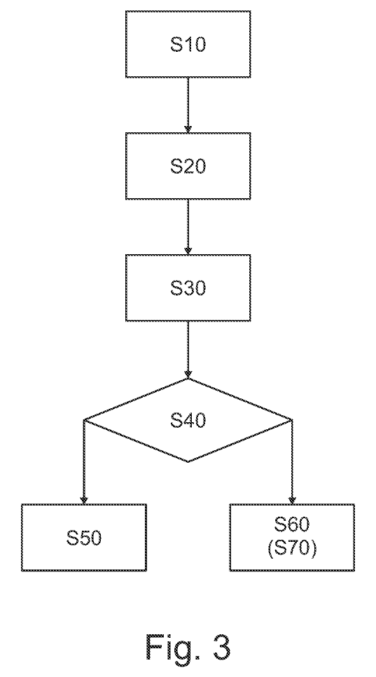

FIG. 3 shows a schematic representation of a computer-implemented method for monitoring a medical monitoring system. The medical monitoring system comprises at least one server with a gateway and at least one medical device that can establish a communication link with each other. The method comprises the following steps.

Step S10 comprises detecting the existence of a communication link between the server and the medical device. To this end, a detecting unit evaluates a heartbeat from the medical device. If a corresponding signal is present, a communication link exists.

Step S20 comprises detecting operating data for the medical device. For this purpose, the detecting unit receives operating data via the communication link from the medical device, for example information about an upcoming software update.

Step S30 comprises detecting a termination of the communication link between the server and the medical device. To do this, the detecting unit evaluates the heartbeat. If no corresponding signal is received, the communication link is assumed to have been terminated.

Step S40 comprises ascertaining, based on the received operating data, whether the termination of the communication link is either an unintentional termination of the communication link or an intentional termination of the communication link. To this end, an ascertaining unit compares whether the operating data indicates an intentional termination of the communication link. In this case, the software update causes a temporary interruption in the communication link. The ascertaining unit recognizes this because it has received the corresponding operating data in advance in step S20. The result is therefore an ascertained intentional termination of the communication link.

Step S50 comprises transmitting a first signal, wherein the first signal comprises an acoustic alarm signal, when an unintentional termination is ascertained. In this case, no initial signal is transmitted because an intentional termination has been ascertained.

Step S60 comprises transmitting a second signal, wherein the second alarm signal does not comprise an acoustic alarm signal, when an intentional termination is ascertained. In the present case, a second signal is transmitted by a transmitting unit to, for example, mobile devices of medical personnel because an intentional termination has been ascertained. According to an advantageous aspect, step S60 may further comprise or may be followed by a further step S70, namely automatically establishing a new communication link 107 between the infusion pump 104 and the server 102 after the software update.

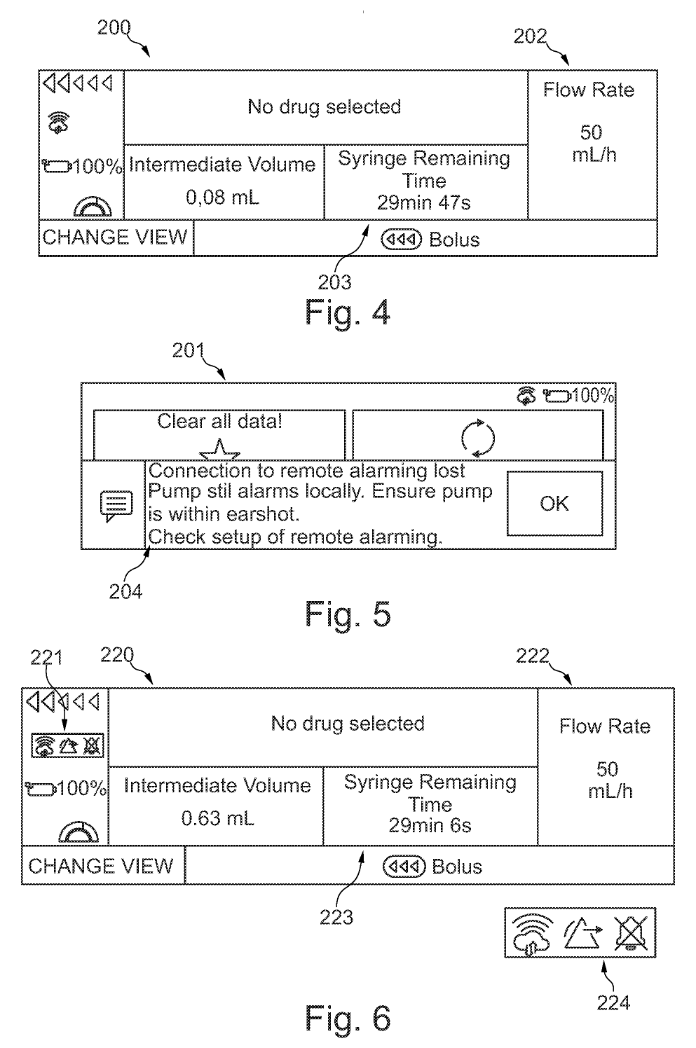

FIG. 4 shows an example of display 201 of an infusion pump with an intentional termination of the communication link. In other words, the infusion pump is not assigned to a distributed alarm system. In this state, different values such as flow rate 202 and remaining infusion time 203 are shown on the display 201. No audible alarm was emitted when exiting the distributed alarm system.

FIG. 5 shows an example of display 201 in a state where communication link has been unintentionally terminated. In the state of an unintentionally terminated communication link, a warning 204 appears on display 201 indicating that the communication link to the distributed alarm system has been terminated. The infusion pump also emits an audible alarm in addition to warning 204.

FIG. 6 shows an example display 220 of an infusion pump when a communication link exists. The normal values such as flow rate 222 and remaining infusion time 223 continue to be displayed. The display continues to indicate that the audible alarm signal 224 on the infusion pump is muted. This is displayed in the region 221. In other words, the display in the region 221 informs a user that the communication link between the infusion pump and the server is established, that the infusion pump is logged into the distributed alarm system, and that in the event of a dangerous situation, an audible alarm will not sound on the infusion pump but, for example, on a nurse's mobile device.

### LIST OF REFERENCE SIGNS

10 device

11 detecting unit

12 ascertaining unit

13 transmitting unit

100 medical monitoring system

101 device

102 server with gateway

103 organization system

104 infusion pump

105 medical device

106 patient monitor

107, 108, 109, 110 communication link

200, 201, 220 display

202, 222 flow rate

203, 223 infusion duration

204 warning

221 display region

224 faded acoustic alarm signal

S10 detecting the existence of a communication link

S20 detecting operating data for medical devices

S30 detecting a termination of the communication link

S40 ascertaining unintentional termination or intentional termination of the communication link based on the operating data

S50 transmitting a first signal in case of unintentional termination

S60 transmitting a second signal in case of intentional termination

S70 automatic re-establishment of a communication link

between medical device and server after software update

1. A device configured for monitoring a distributed alarm system, the distributed alarm system having at least one server and at least one medical device configured to establish a communication link with the at least one server, the device comprising:
a detecting unit;
an ascertaining unit; and
a transmitting unit,
the detecting unit configured to detect the communication link between the at least one server and the at least one medical device,
the detecting unit also configured to detect operating data for the at least one medical device,
the detecting unit further configured to detect a termination of the communication link between the at least one server and the at least one medical device,
the ascertaining unit configured to ascertain, based on the operating data, whether the termination of the communication link is either an unintentional termination of the communication link or an intentional termination of the communication link,
the transmitting unit configured to transmit a first signal that includes an acoustic alarm signal when an unintentional termination is ascertained, and
the transmitting unit is further set up to transmit a second signal, wherein the second signal does not comprise an acoustic alarm signal, when an intentional termination is ascertained.

2. The device according to claim 1, wherein the operating data indicate one or more of the following: a physical separation of participants from the distributed alarm system, a software update, maintenance of participants, maintenance of the at least one server, and maintenance of a gateway.

3. The device according to claim 1, wherein the at least one server comprises a gateway for converting data logs.

4. The device according to claim 1, wherein the first signal and/or the second signal comprises a visual signal.

5. The device according to claim 1, wherein the device is configured for monitoring a distributed alarm system having a plurality of medical devices and/or other participants.

6. The device according to claim 1, wherein the device is configured for monitoring a distributed alarm system that includes an infusion pump.

7. The device according to claim 1, wherein the device is configured to automatically establish a new communication link between the at least one medical device and the at least one server when the ascertaining unit ascertains that the termination of the communication link is intentional.

8. The device according to claim 7, wherein the device is configured to automatically establish the new communication link between the at least one medical device and the at least one server when the ascertaining unit ascertains that the termination of the communication link is caused by a software update.

9. The device according to claim 1, wherein the first signal and/or the second signal is transmitted to the at least one server for forwarding to further medical devices and/or participants.

10. A medical monitoring system comprising:
the device for monitoring the distributed alarm system according to claim 1;
a server with a gateway; and
at least one medical device.

11. The medical monitoring system according to claim 10, wherein the at least one medical device comprises at least one infusion pump.

12. A computer-implemented method for monitoring a distributed alarm system, the distributed alarm system having at least one server and at least one medical device configured to establish a communication link with the at least one server, the computer-implemented method comprising the steps of:
detecting a communication link between the at least one server and the at least one medical device;
detecting operating data for the at least one medical device;
detecting a termination of the communication link between the at least one server and the at least one medical device;
ascertaining, based on the operating data, whether the termination of the communication link is either unintentional or intentional;
transmitting a first signal that comprises an acoustic alarm signal when an unintentional termination is ascertained;
transmitting a second signal that does not comprise an acoustic alarm signal when an intentional termination is ascertained.

13. The computer-implemented method according to claim 12, wherein the operating data indicates one or more of the following situations: physical separation of a participant from the distributed alarm system, a software update, maintenance of participants, maintenance of the at least one server, and maintenance of a gateway.

14. The computer-implemented method according to claim 12, wherein the at least one server comprises a gateway for converting data logs.

15. A computer-readable non-transitory storage medium comprising commands which, when executed by a computer, cause the computer to carry out the computer-implemented method according to claim 12.
